(19) United States
(12) Patent Application Publication
(10) Pub. No.: US 2023/0214316 A1
(43) Pub. Date: Jul. 6, 2023

(54) SYSTEM AND METHOD FOR AUTONOMOUS COGNITIVE TEST STRATAGEM (ACTS)

(71) Applicant: US TECHNOLOGY INTERNATIONAL PVT. LTD., Trivandrum Kerala (IN)

(72) Inventors: Jermy JOSE, Ettumanoor Kottayam Kerala (IN); Jaya MOHAN, Kuzhimathikadu Kollam Kerala (IN); Praveen PRABHAKARAN, Ilford (GB)

(21) Appl. No.: 18/148,204

(22) Filed: Dec. 29, 2022

(30) Foreign Application Priority Data
Dec. 30, 2021 (IN) 202141061910

(51) Int. Cl. G06F 11/36

(52) U.S. Cl. CPC G06F 11/3684

(57) ABSTRACT

The present invention relates to a system and method for autonomous cognitive test stratagem. The Autonomous Cognitive Test Stratagem (ACTS) is an application that is designed to generate a test strategy document based on a response to a set of questions. The questions are selected based on a current Quality Engineering (QE) principles and QE Taxonomy.

### FIELD OF THE INVENTION

The present disclosure, in general, relates to a system and method for autonomous cognitive test stratagem (ATS). In particular, the present invention provides a system and method to generate a test strategy document and provide a recommendation based on response to a set of questions.

### BACKGROUND

It is known to create a test strategy document for accurate interpretation of the landscape and business objective behind the project/team. Further, it is also known to elaborate the testing objectives of the program/project in a test strategy document. Thus, for any strategy there is a needs to be an accurate interpretation covering all the aspect of the business. Thus, proper attributes need to be considered during the design.

According to the conventional art the test strategy document is created manually. Thus, such approach becomes a time consuming process. Further, creating a test document is a tedious task thus, a client may miss some of the important attributes to consider while preparing the document manually. This may lead to a misinterpretation of the landscape and business objective behind the project/team.

Thus, as may be seen, there exists a need to provide a methodology in order to overcome one of the above-mentioned problems.

### SUMMARY

This summary is provided to introduce a selection of concepts, in a simplified format, that are further described in the detailed description of the invention. This summary is neither intended to identify key or essential inventive concepts of the invention and nor is it intended for determining the scope of the invention.

The present disclosure relates to a system and method for autonomous cognitive test stratagem. The Autonomous Cognitive Test Stratagem (ACTS) is a web-based application that is designed to generate a customized test strategy document based on a response to a set of questions. The questions are selected based on a current Quality Engineering (QE) principles and QE Taxonomy. The present disclosure also provides a recommendation based on the customised test strategy documents.

According to the present disclosure, a method for automatically generating a customized test strategy document and providing recommendation is disclosed. The method comprises selecting by a user, a test type from a set of test types, wherein the test type is indicative of required functionality for a test project. The method further comprises outputting a first question associated with the selected test type along with a first set of options, based on a (Quality Engineering) QE taxonomy having a plurality of attributes defined for the selected test type. Thereafter, the method further comprises selecting, by the user, at least one option, as a first response from the first set of options to the first question. Thereafter, the method generates a second question associated with the selected test type based on the first response to the first question, wherein the second question is generated along with a second set of options. The method further includes selecting, by the user, at least one options, as a second response from the second set of options to the second question and then assigns a second score to the selected second option based on the plurality of attributes in the QE taxonomy. The method then analyses a total response based on at least one of the first response and the second response and generates a customized test strategy document for the selected test type based on the analysis. Thereafter, the method recommends at least one missing attribute from the plurality of attributes based on at least one of a total score obtained from first score and the second score and the customized test strategy document.

To further clarify advantages and features of the present invention, a more particular description of the invention will be rendered by reference to specific embodiments thereof, which is illustrated in the appended drawings. It is appreciated that these drawings depict only typical embodiments of the invention and are therefore not to be considered limiting of its scope. The invention will be described and explained with additional specificity and detail with the accompanying drawings.

### BRIEF DESCRIPTION OF THE DRAWINGS

These and other features, aspects, and advantages of the disclosure will become better understood when the following detailed description is read with reference to the accompanying drawings in which like characters represent like parts throughout the drawings, wherein:

FIG. 1 illustrates an QE Taxonomy, according to an embodiment of the present disclosure.

FIG. 2(a) illustrates a general flow diagram of the ACTS, according to an embodiment of the present disclosure.

FIG. 2(b) illustrates a block diagram of the ATCS 200, according to an embodiment of the present disclosure.

FIG. 3 illustrates a flow chart for automatically generating a customized test strategy document and providing recommendation, according to an embodiment of the present disclosure.

FIG. 4 illustrates a detailed work flow diagram for the generation of the customised test strategy document, according to an embodiment of the present disclosure.

FIG. 5 shows a scoring mechanism, according to an embodiment of the present disclosure.

FIG. 6 illustrates a recommendation mechanism, according to an embodiment of the present disclosure.

FIG. 7(a)-(s) illustrates an exemplary scenario for generating a test strategy document, according to an embodiment of the present disclosure.

FIG. 8 illustrates an architecture diagram of the ACTS, according to an embodiment of the present disclosure.

FIG. 9 illustrates yet another exemplary implementation of typical hardware configuration of the system 200, according to an embodiment of the present disclosure.

Further, skilled artisans will appreciate that elements in the drawings are illustrated for simplicity and may not have been necessarily been drawn to scale. For example, the flow charts illustrate the method in terms of the most prominent steps involved to help to improve understanding of aspects of the disclosure. Furthermore, in terms of the construction of the device, one or more components of the device may have been represented in the drawings by conventional symbols, and the drawings may show only those specific details that are pertinent to understanding the embodiments of the disclosure so as not to obscure the drawings with details that will be readily apparent to those of ordinary skill in the art having benefit of the description herein.

### DETAILED DESCRIPTION OF FIGURES

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are explanatory of the invention and are not intended to be restrictive thereof

Reference throughout this specification to “an aspect”, “another aspect” or similar language means that a particular feature, structure, or characteristic described in connection with the embodiment is included in at least one embodiment of the disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

According to the embodiment of the present disclosure, a system and method for autonomous cognitive test stratagem. The Autonomous Cognitive Test Stratagem (ACTS) is an application that is designed to generate a test strategy document based on a response to a set of questions. The generated test strategy document is a customized test strategy documents that were generated for a test type that was selected by a user for a particular test project. The ACTS further provides a recommendation based on the test strategy document The questions are selected based on a current Quality Engineering (QE) principles and QE Taxonomy that are defined in accordance with predefined standards. A detailed working of the same will be disclosed in the below paragraphs.

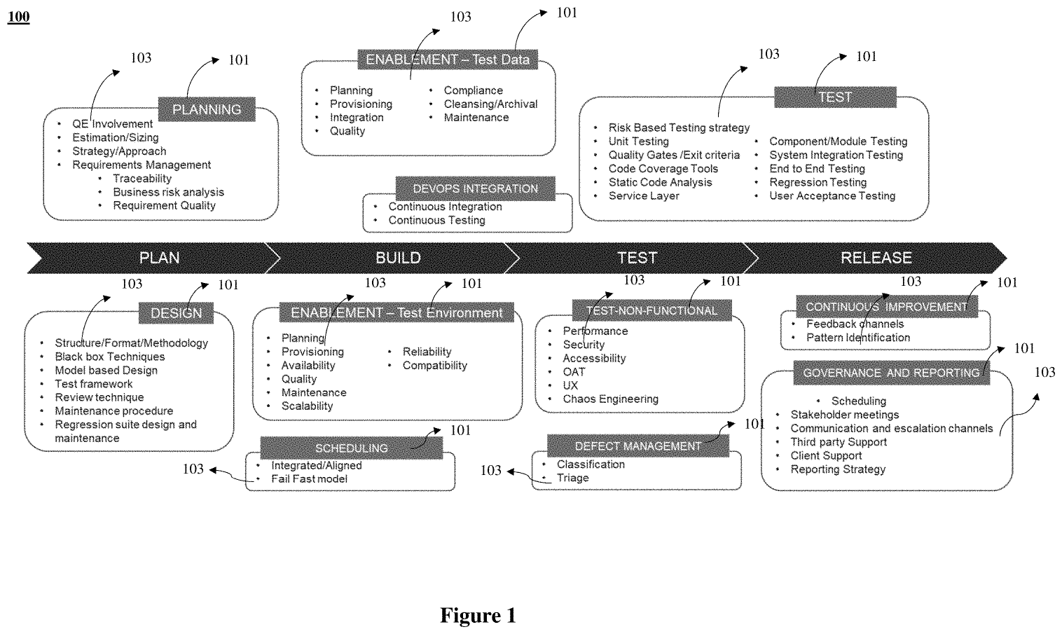

FIG. 1 illustrates an QE Taxonomy, according to an embodiment of the present disclosure. The QE taxonomy 100 is designed against latest QE principles and best practices in QE. It ensures that any QE approach considers all possible attributes when defined. ACTS tool is based on the QE taxonomy and utilizes the QE Taxonomy to evaluate a quality of the approach and identify if there are major gaps. Further, the ACTS tool also provides recommendation for the same. ACTS plays the role of a test consultant as it has a repository of industry and org specific benchmarks that are stored in its repository. Accordingly, the ACTS tool and its one or more attributes are defined in accordance with a predefined standards for the test project. As shown in the FIG. 1, one or more QE Taxonomy 101 is shown. Further, various attributes 103 that is to be consider under each QE Taxonomy 101 is shown in the FIG. 1. As can be understood from the FIG. 1 the one or more QE Taxonomy 101 may include, for example, but not limited to, planning, enablement-test data, test, design, enablement-test environment, test-non functional, continuous improvement, scheduling, defect management, governance and reporting. Further, the one or more attributes 103 are defined as QE taxonomy elements in accordance with the predefined standards of the QE taxonomy. As can be understood from the FIG. 1, the plurality of attributes 103 under planning may be defined as for example, QE involvement, estimation/Sizing, Strategy/Approach, requirement management and the like.

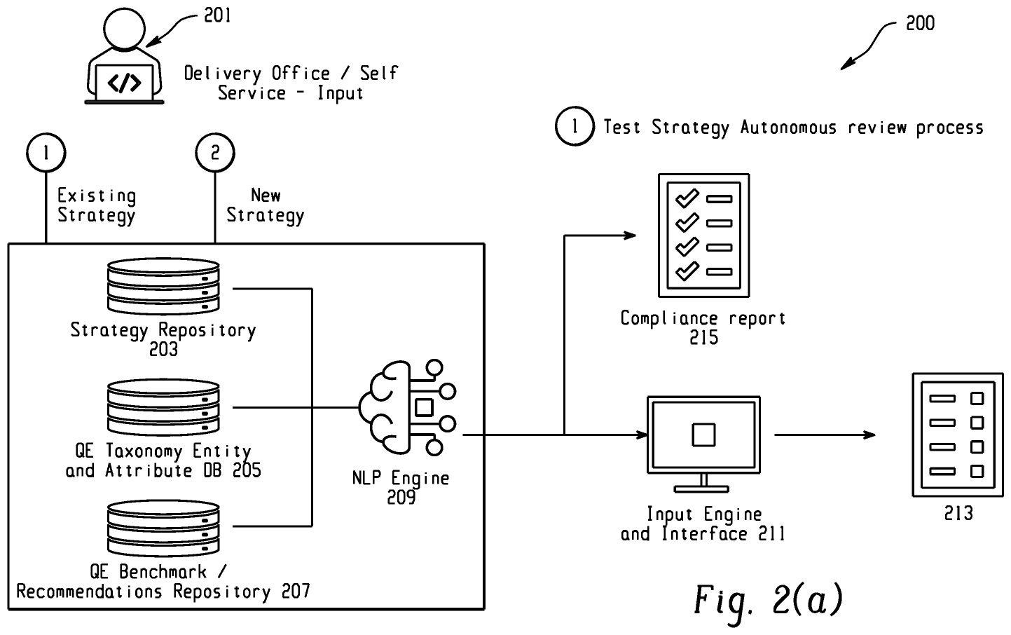

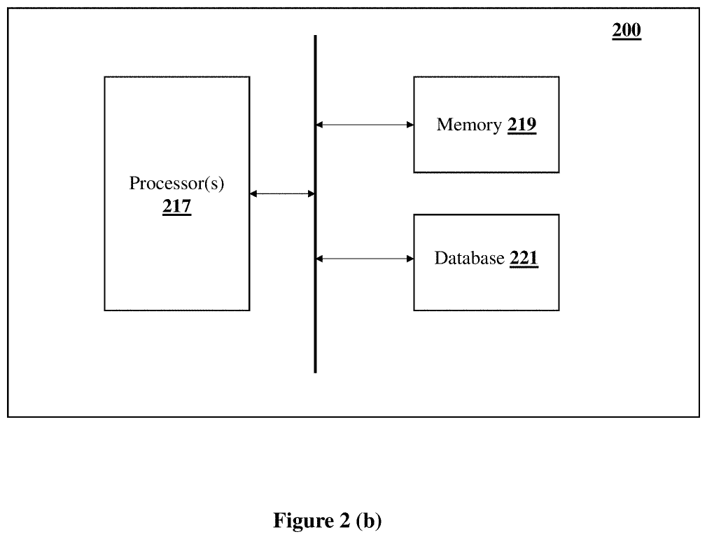

FIG. 2(a) illustrates a general flow diagram of the ACTS, according to an embodiment of the present disclosure. The ACTS 200 is a web-based tool that can be accessed by any individual/client with valid credentials. As an alternative, the ACTS may be referred as an Application 200 and/or system 200 without deviating from the scope of the disclosure. Further, the reference numerals have been kept the same for the similar entities as applicable throughout the drawings for the sake of simplicity and better understanding, without deviating from the scope of the disclosure.

According to an embodiment, the ACTS application 200 may be access within a proprietary network and subject to multifunction authentication (MFA). The application 200 is compatible with different browsers and may also be rendered on portable devices. The application 200 may also have the capability of reviewing existing strategies and providing a compliance against the QE Taxonomy 100 and provide recommendations against the industry benchmarks.

According to an embodiment, the ATCS 200 is configured to autogenerate the customized test strategy document without much manual effort to a user/client. The ATCS 200 requires some inputs from the user to generate the document. User may get a series of questions with/without options. The design is flexible and elements such as the questionnaire, answers and boiler text are configurable.

Now referring back to the FIG. 2, a user 201 may access the ATCS 200 after successful validation of the user. In particular, the user has to priorly register with the ATCS 200. Now for accessing the ACTS 200 the user has to go with a validation procedure by using the given credential of the user.

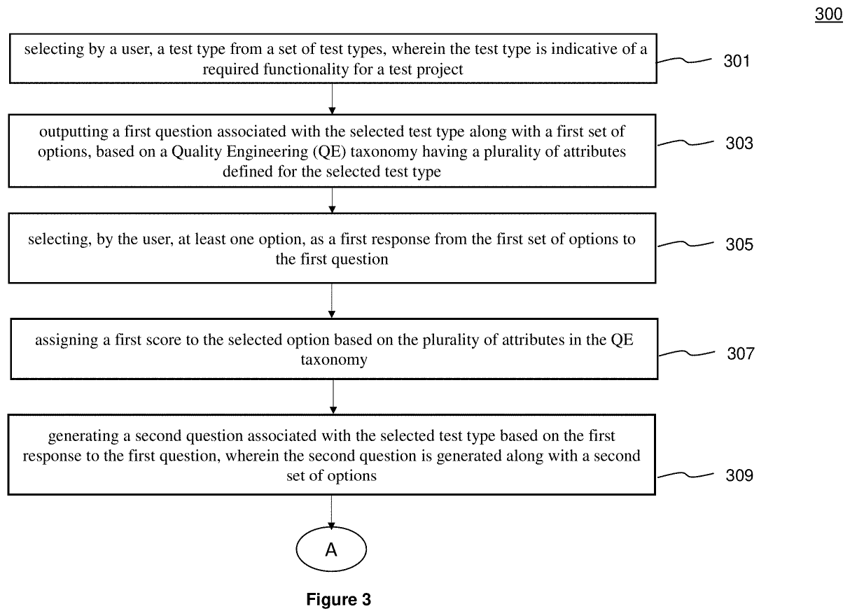

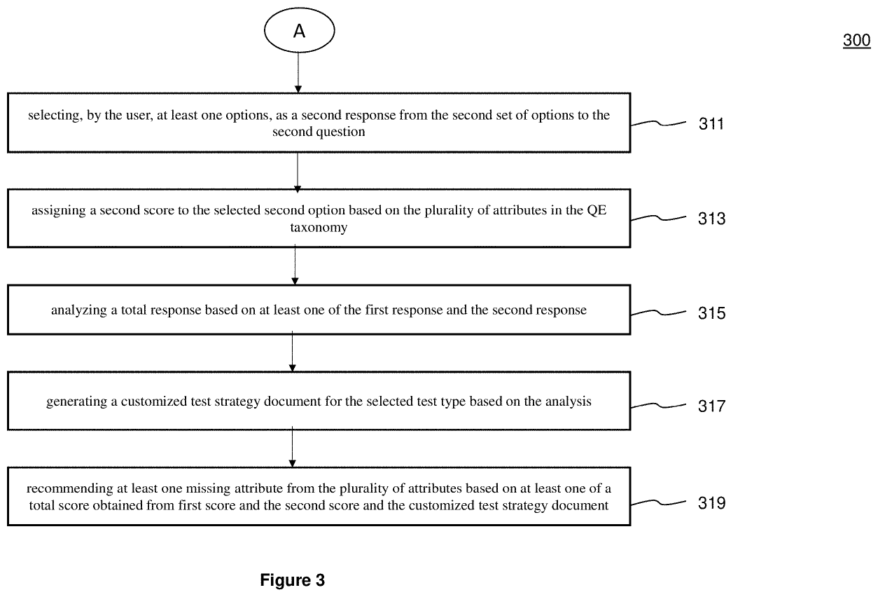

According to an embodiment, the ATCS 200 includes, for example, a statutory repository 203, a QE taxonomy entity and attribute DB 205, and a QE benchmark Recommendation's repository 207. According to an embodiment, the QE taxonomy 100 is stored in the QE taxonomy entity and attribute DB 205. FIG. 3 illustrates a flow chart for automatically generating a customized test strategy document and providing recommendations, according to an embodiment of the present disclosure. The FIG. 3 will be explained in collaboration with FIG. 2 for ease of explanation. As disclosed in the FIG. 3, a method 300 is implemented in the ATCS 200. According to an embodiment FIG. 2(b) illustrates a block diagram of the ATCS 200, according to an embodiment of the present disclosure. As an example, the ATCS 200 system includes one or more processors 217 coupled with a memory 219 and database 221. The database 221 may include the QE taxonomy entity and attribute DB 205, the QE benchmark Recommendation's repository 207 and a strategy repository 203. According to an embodiment, the one or more processor(s) 217 may be configured to implement the method 300.

Initially, at step 301, the system 200 may be configured to select, a test type from a set of test types by the user. According to an embodiment the test type is indicative of a required functionality for a test project.

According to an embodiment as shown in strategy 2 of the FIG. 2(a), the user provides an input to select a test type from a set of test types. As an example, the set of test types corresponds to the QE Taxonomy 100 as shown in the FIG. 1. For example, lets us consider that the user has selected an enablement-test data. Thereafter, let us consider that the user has selected an attribute that corresponds to planning. Accordingly, based on the aforesaid inputs a set of questions were presented to the user.

After the step 301, the method 300 proceed to perform the method at step 303. The system 200 may be configured to output a first question associated with the selected test type along with a first set of options, based on the Quality Engineering (QE) taxonomy having the one or more of attributes defined for the selected test type

As an example, the first question related to planning may be outputted to the user. The first question associated with the selected test type along with a first set of options may be generated and outputted to the user. According to the embodiment the first question for the selected test type in this exemplary case for planning may be stored in the QE taxonomy entity and attribute DB 205. Thus, based on the selected test type the first question were derived from the QE taxonomy entity and attribute DB 205.

After generating the first set of questions at step 303, at step 305 the user may select at least one option, as a first response to the first question. Thereafter, at step 307, the system 200 assigns a score to the selected option based on the plurality of attributes in the QE taxonomy. In particular, the assigning of the score to the selected option of the first question may include comparing the first response with a standard response that is predefined for the selected test type in the QE taxonomy 101 for each of the attribute 103 in the QE taxonomy 101 for the selected test type. Thereafter, based on the comparison, the system 200 assigns the first score. According to the embodiment the assigned score is indicative of a deviation of response from the standard response.

Continuing with the same example, let's say for the selected test type i.e. planning an appropriate response is already being defined in the QE taxonomy entity and attribute DB 205. Thus, based on the test type which is planning here a first question was generated and thereby outputted to the user. Then the user provides its response to the first question. Thereafter, the response of the user is being compared with the standard response. As an example, the standard response are the steps that should be followed by the user for the selected test type in order to get an appropriate strategy. Thus, based on the comparison the score is being assigned to the user's response.

Now after, getting the user response to the first question, the system 200, at step 309, may be configured to generate a second question associated with the selected test type based on the first response to the first question. According to the embodiment, the second question is generated along with a second set of options. Now similar to the step 305 and 307 as explained above, the steps 311 and 313 are similar. In particular, the at steps 311 and 313, the system 200, the user selects at least one options, as a second response from the second set of options to the second question and then assigns a second score to the selected second option based on the plurality of attributes in the QE taxonomy respectively. In particular, the assigning of the score to the selected option of the second question may include comparing the second response with a standard response that is predefined for the selected test type in the QE taxonomy 101 for each of the attribute 103 in the QE taxonomy 101 for the selected test type. Thereafter, based on the comparison, the system 200 assigns the score. According to the embodiment the assigned score is indicative of deviation of response from the standard response.

According to an example, in the ACTS 200, each option for the objective type question has a specific score. Based on the options selected, the total score is calculated and the total score for Test Strategy is sent to the user along with the customized test strategy document. The scoring mechanism is shown in the table 1.

TABLE 1

| | | | | Total |
|---|---|---|---|---|
| Test Type | Questions | Options | Score | Score |
| Planning | Select the | Unit testing | 1 | 10 |
| | testing | Smoke testing | 1 | |
| | types that | Interface testing | 1 | |
| | are in scope | System testing | 1 | |
| | | Regression testing | 1 | |
| | | Security testing | 1 | |
| | | Performance testing | 1 | |
| | | Accessibility testing | 1 | |
| | | Operational acceptance testing | 1 | |
| | | User acceptance testing | 1 | |

According to an embodiment, based on the response of the user to the previous set of questions and the QE taxonomy 100, the next set of question were presented to the users. Accordingly, a series of questions were presented to the user and the responses of the user were compared and assigned scores. Thus, the process was continuous till all responses of the user were analysed with respect to one or more attributes 103.

Continuing with the method 200, after the step 313, at step 315, the system 200 may be configured to analyze a total response based on at least one of the first responses and the second response and then at step 317, the system 200 may be configured to generate a customized test to strategy document for the selected test type based on the analysis. As shown in the FIG. 2(a) the test strategy report 213 may be generated after analysing the total user response. As an example, the test strategy report 213 is the customized test strategy document.

According to an embodiment, for the generation of the test strategy report 213 a predefined boiler text, from a database 221, respective of each of the selected options are retrieved and the customized test strategy document are generated based on the retrieved predefined boiler text and the selected options. Thus, the present mechanism helps the user to autogenerate the test strategy document without much manual effort.

According to a further embodiment, the ATCS 200 reviews existing tests strategies which are not generated by ACTS and identify the gaps against the QE Taxonomy and provide recommendations on the missing attributes. Furthermore, the ATCS 200 may also be further configured to review the test strategy report 213 generated by ACTS 200 and identify the gaps against the QE Taxonomy and provide recommendations on the missing attributes based on a scoring mechanism.

Thus, continuing with the method 200, after the step 317, at step 319, the system 200 may be configured to recommend at least one missing attribute from the plurality of attributes based on at least one of a total score obtained from first score and the second score and the customized test strategy document.

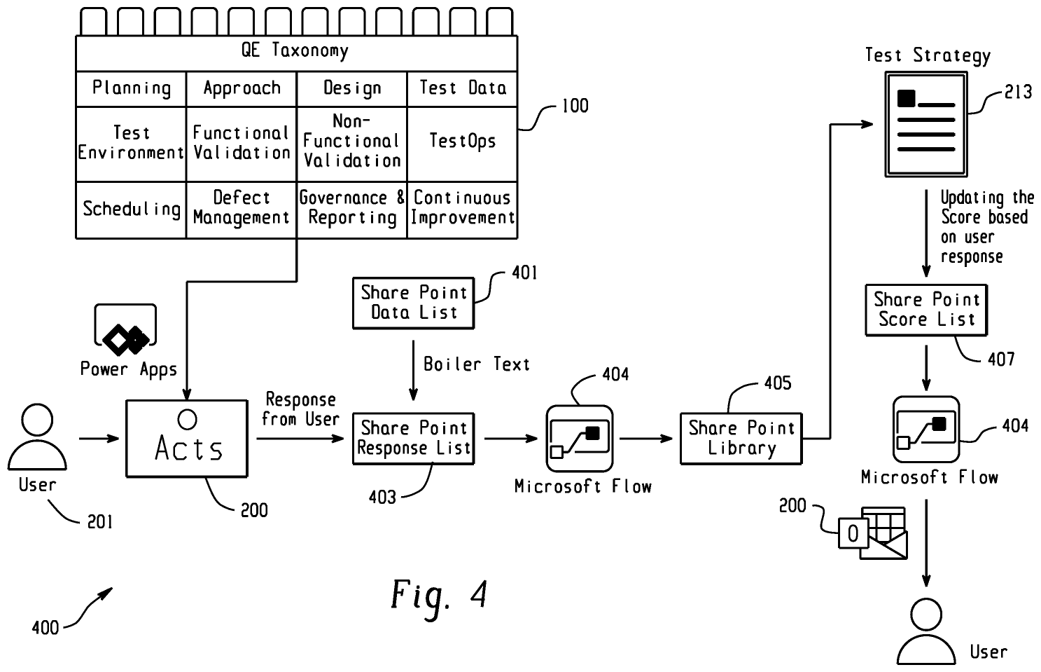

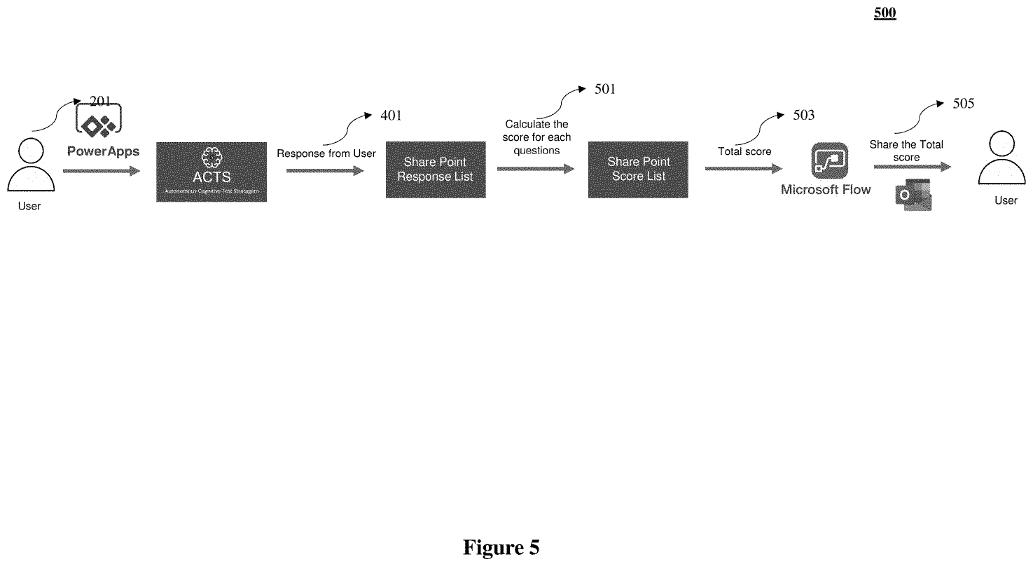

FIG. 4 illustrates a detailed work flow diagram for the generation of the customized test strategy document, according to an embodiment of the present disclosure. The FIG. 4 will be explained while referring to the FIGS. 1-3 for ease of explanation and sake of brevity. FIG. 3 illustrates a detailed workflow 400 of the ACTS 200 for the generation of the customized test strategy document. FIG. 5 shows a scoring mechanism, according to an embodiment of the present disclosure. After attending all the questions, the user can click on the ‘Submit’ button to submit the responses 401 as shown in the FIG. 4. The scoring assignment mechanism 500 is already explained in the steps 307 and 313, thus for the sake of brevity the explanation of the same is omitted.

According to an embodiment the application 400 utilizes, at least, PowerApps, Flow, and SharePoint technology which is accessible and can edit it without any source control tool. As explained in the above paragraphs, the application 400 is a web-based tool that can be accessed by any individual with valid credentials. Further, there is a series of set of objective questions, and each question may be mandatory are presented to the user. Each option has specific score and the score for each question is calculated based on the options selected by the user. Further, each of the score may be updated based on the user response as shown in the FIG. 4. As an example, the score as shown in the table 1 will be updated based on the user response. According to a further embodiment, the total score which is obtained by the analysing all the score may be shared with the user at step 505 of FIG. 5. According to an embodiment the total score may be shared with the user by mentioning in an email body.

As shown in the FIG. 4, the ACTS 200 is coupled with the QE taxonomy 100 via a database 221. According to an embodiment, there is a SharePoint Data List 401 where a Boiler text for each option is stored. Once a submit button is clicked by the user to submit the response, the corresponding boiler text based on the option selected by the user will be updated on a SharePoint Response List 403. When an entry is created in the SharePoint Response List 403, a Microsoft Flow 404 may get triggered for generating the Test Strategy Document 213 in the SharePoint Library 405 with the specific boiler texts and responses from the user.

According to an embodiment, at the same time, a total score for the user is calculated based on the options and may be updated in the SharePoint Score List 407 with the user details as shown in the FIG. 5. When a new strategy document is created in the SharePoint Library 405, a Microsoft Flow 404 may get triggered and the created document will be sent to the corresponding user through e-mail services.

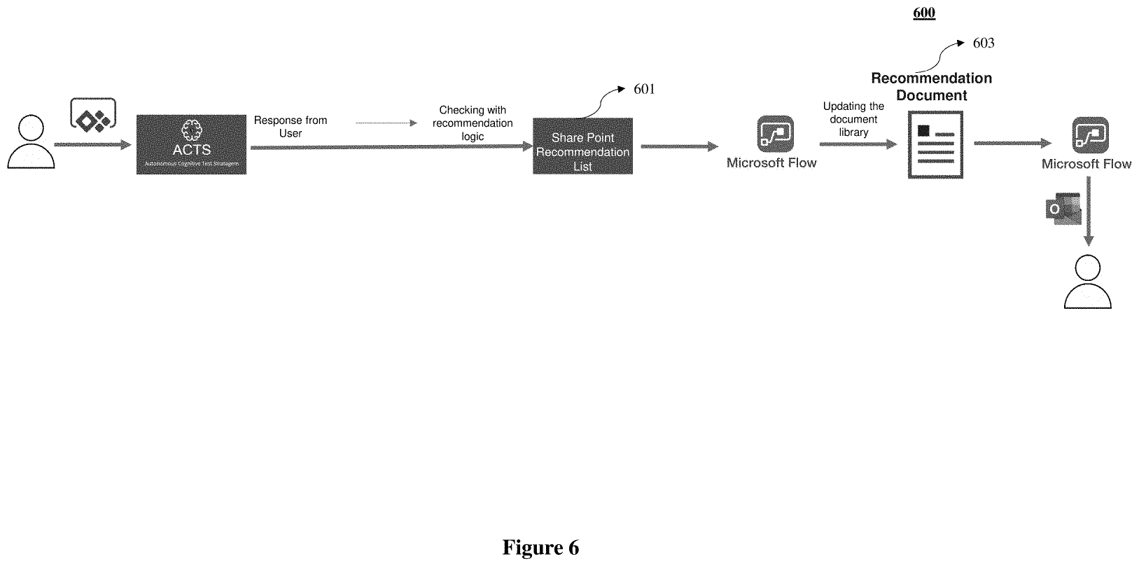

FIG. 6 illustrates a recommendation mechanism, according to an embodiment of the present disclosure. According to an embodiment, the evaluation of the test strategy document will be done at the time of document creation. According to the recommendation mechanism 600, the ACTS 200 will capture all the inputs/response from the user and check the same with a predefined recommendation logic which is already in the ACTS 200. For example, if the user has not selected for a required field/ option or the project is not following a methodology which is very important, there will be a recommendation from the ACTS 200. The recommendation texts are stored in the share point recommendation list 601 and mapped with different logics. When the logic returns true, the ACTS 200 may update the recommendation document. The recommendation/evaluation report 603 may be sent as an email. There can be multiple recommendations for a single test strategy according to the test strategy. Accordingly, the ACTS 200 reviews the existing tests strategies which may or may not be generated by ACTS 200 and identify the gaps against the QE Taxonomy and provide recommendations on the missing attributes.

According to an exemplary embodiment, it is recommended to include unit testing in a project as it is a proven technique to ensure software quality. It ensures that all code meets quality standards before it's deployed. This ensures a reliable engineering environment where quality is paramount. Over the course of the product development life cycle, unit testing saves time and money and helps developers write better code, more efficiently.

As per the selection based on the user response, consider a scenario where the user has not selected User acceptance testing (UAT) in his project. Further, the UAT testing helps in validating whether the developed software is functioning according to the requirements specified by clients and if it meets all the user stories as defined. It serves as a final check to ensure the finished product will be bug-free, which will lead to customer satisfaction and increase the company's reputation. So, the ACTS 200 recommends including User acceptance testing in its project as it helps in the following areas:
It keeps ongoing maintenance costs as low as possible.
it provides optimal opportunities to identify and repair broken features/usability issues.
it provides an end-user's vision.
it Increases software robustness and usability.
it Increases end-user happiness.

Further, according to another exemplary scenario, the ACTS 200 may recommend that the client has not opted for Interface testing for his project. Further, the recommendation may include recommending following as it helps in the following areas:
To verify communication between the systems are done correctly.
To verify if all supported hardware/software has been tested.
To verify if all linked documents are supported/opened on all platforms.
To verify the security requirements or encryption while communication happens between systems.
To verify if a Solution can handle network failures between a Web site and application server.

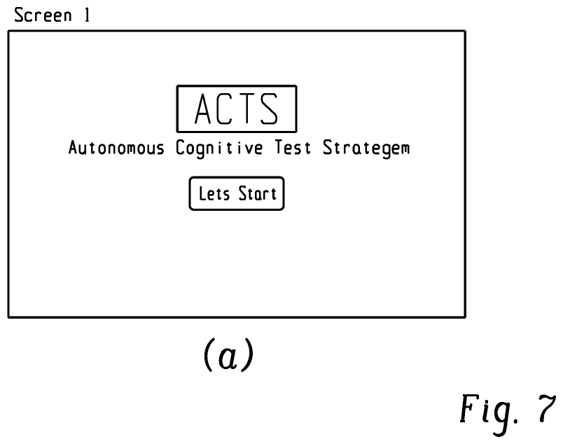

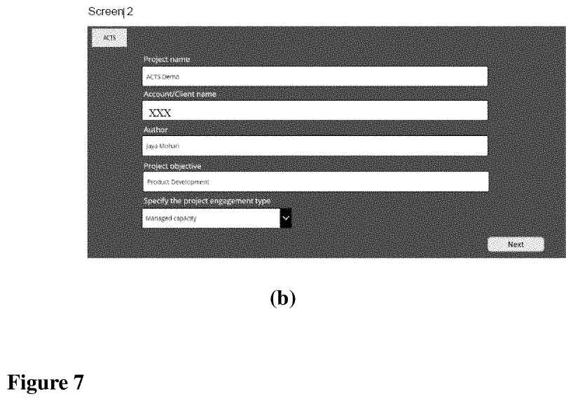

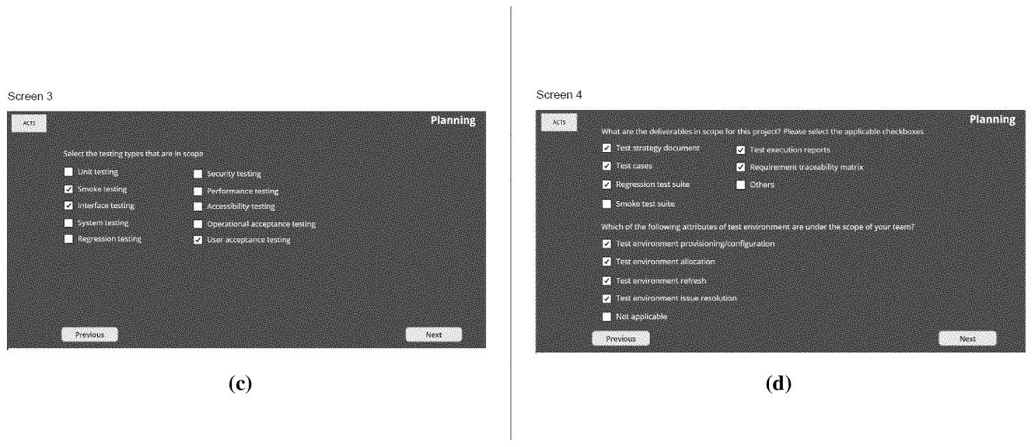

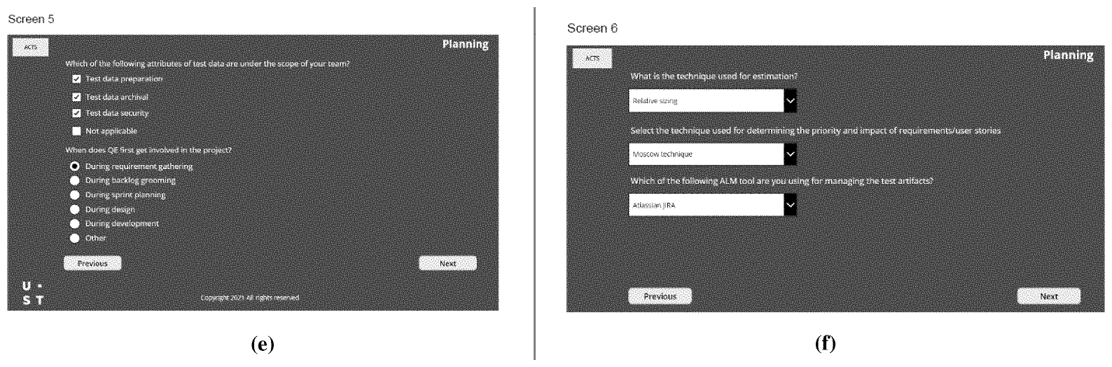

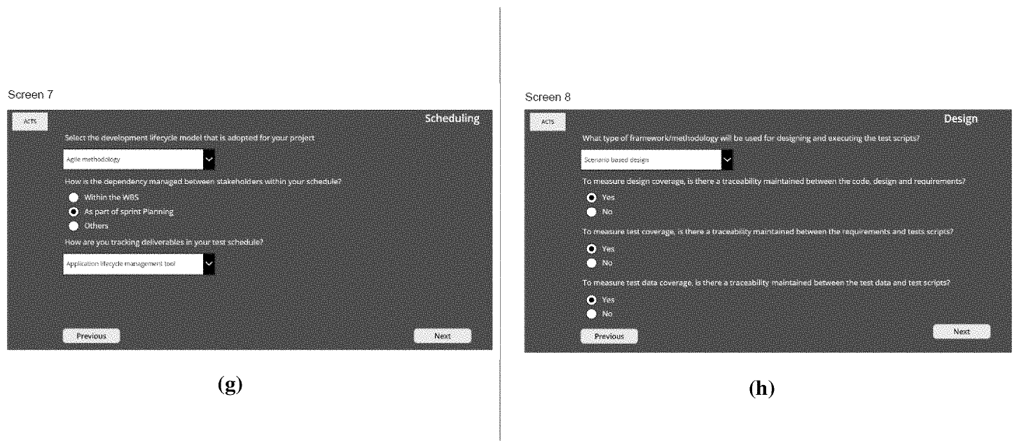

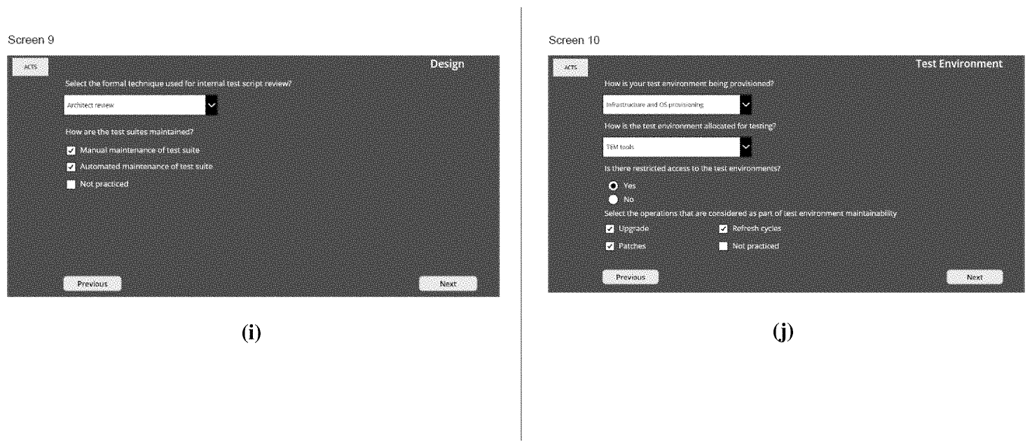

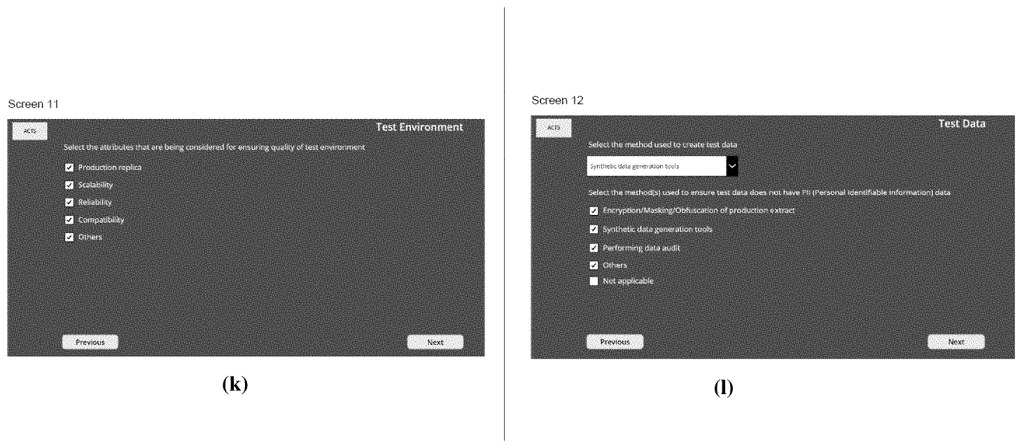

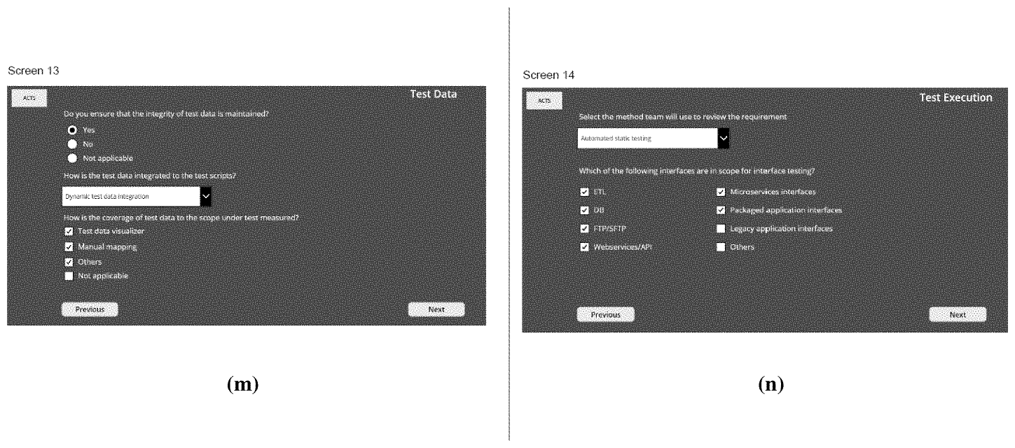

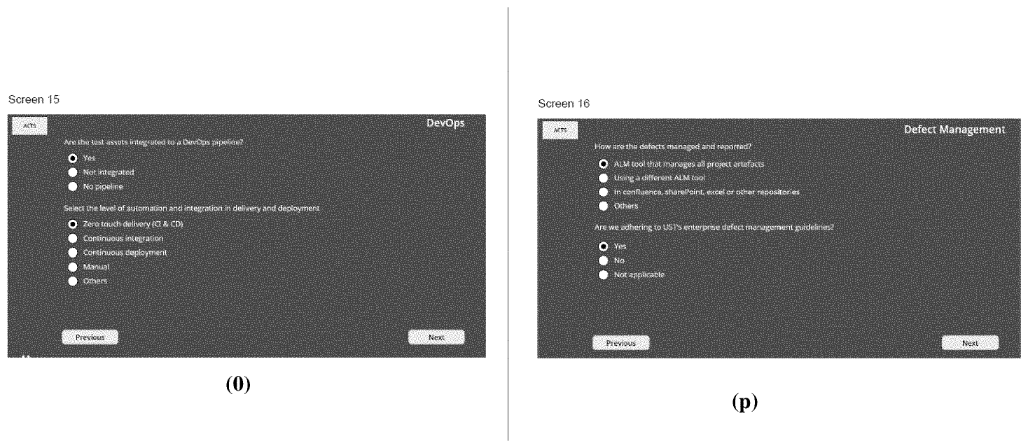

FIG. 7(a)-(s) illustrates an exemplary scenario for generating a test strategy document, according to an embodiment of the present disclosure. According to an embodiment the ACTS application 200 consists of one or more objective questions. The user must attend all the questions provided in the ACTS application 100 to successfully generate a customized test strategy document. According to an embodiment, the Application 200 is developed in such a way that the user can navigate from one screen to another only after providing information to all the mandatory fields. The user can navigate to previous screen by clicking the ‘Previous’ button at any time before clicking the ‘Submit’ button to modify the answers provided by them. By clicking on ‘Submit’ button the customized test strategy word document will be generated, and within 5 minutes the user will receive an email with the document attached in their inbox.

As shown in the FIG. 7(a) in the screen 1 ACTS 200 application gets initialised. Thereafter at 7(b) at screen 2 various credentials has to filled by the user. Then at screen 3, the user has to select type of the testing he performed while achieving the objectives. Now according to the selected test type at FIG. 7(c) a series of questions were generated as shown in the FIG. 7 (d) at screen 4. Thus, based on the user response the next set of questions where generated and presented to the user. Accordingly, based on the response at the screen 4 next subsequent screens were generated as shown in the FIG. 7(e)-7(q). Further, as explain above each question will be a given score so that a total score is generated for the recommendation. Thus, at last a customized test strategy document may be generated. Further, after evaluation as explained in the FIG. 6 a recommendation document may also be generated.

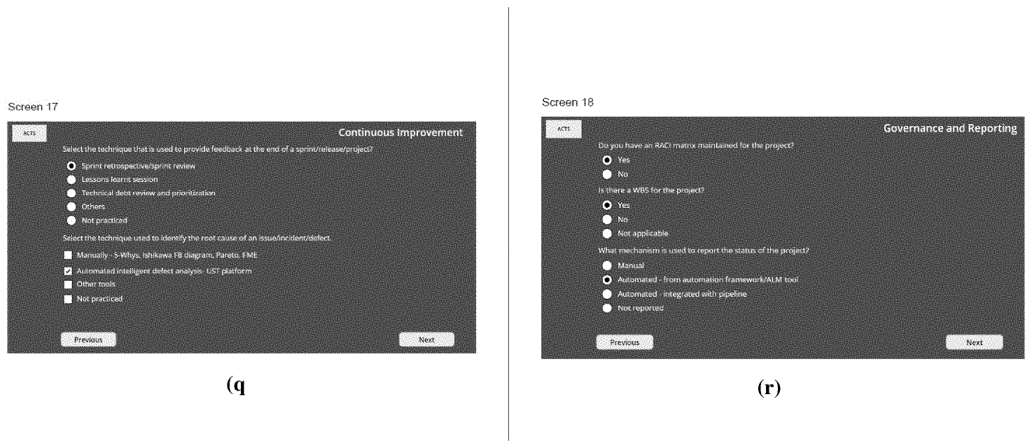

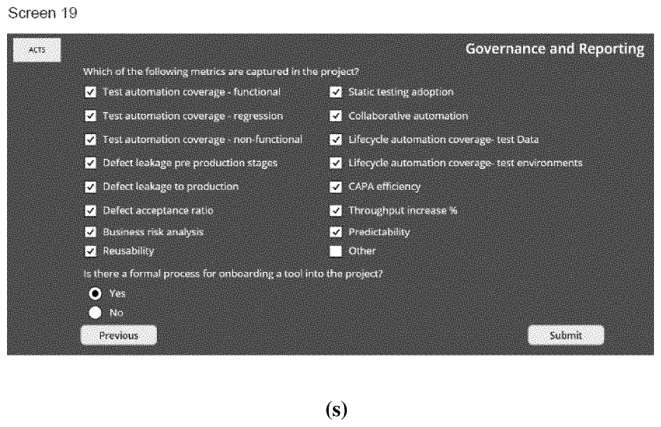

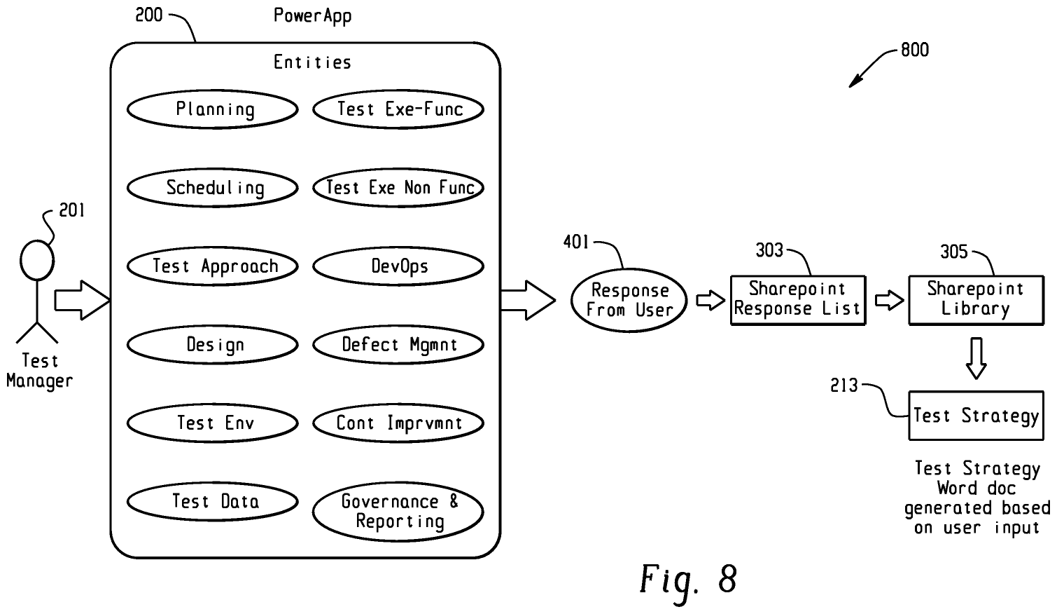

FIG. 8 illustrates an architecture diagram of the ACTS, according to an embodiment of the present disclosure. The architecture 800 is configured to implement the method 300, 400, 500, and 600 as disclosed in the FIGS. 3-6. Thus, for the sake brevity the explanation of the same is omitted here. Further as disclosed the ACTS 200 has processors 217 and memory 219.

In an example, the processor 217 may be a single processing unit or a number of units, all of which could include multiple computing units. The processor 217 may be implemented as one or more microprocessors, microcomputers, microcontrollers, digital signal processors, central processing units, logical processors, virtual processors, state machines, logic circuitries, and/or any devices that manipulate signals based on operational instructions. Among other capabilities, the processor 217 is configured to fetch and execute computer-readable instructions and data stored in the memory 217.

The memory 219 may include any non-transitory computer-readable medium known in the art including, for example, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes.

As an example, a database 221 may be operatively coupled with the ACTS 200. The database 221 may be implemented with integrated hardware and software. The hardware may include a hardware disk controller with programmable search capabilities or a software system running on general-purpose hardware. The examples of database are, but not limited to, in-memory database, cloud database, distributed database, embedded database and the like. The database 221, amongst other things, serves as a repository for storing data processed, received, and generated by one or more of the processors 217.

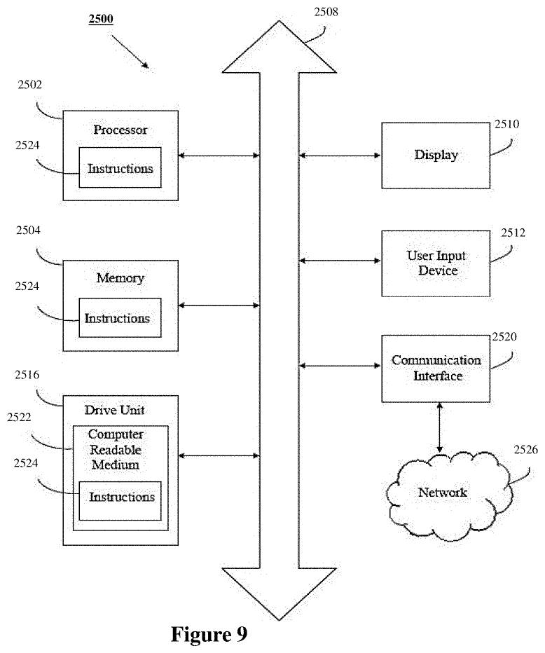

FIG. 9 shows yet another exemplary implementation in accordance with the embodiment of the invention, and yet another typical hardware configuration of the system 200 in the form of a computer system 2500. The computer system 2500 can include a set of instructions that can be executed to cause the computer system 2500 to perform any one or more of the methods disclosed. The computer system 2500 may operate as a standalone device or may be connected, e.g., using a network, to other computer systems or peripheral devices.

In a networked deployment, the computer system 2500 may operate in the capacity of a server or as a client user computer in a server-client user network environment, or as a peer computer system in a peer-to-peer (or distributed) network environment. The computer system 2500 can also be implemented as or incorporated across various devices, such as a personal computer (PC), a tablet PC, a personal digital assistant (PDA), a mobile device, a palmtop computer, a laptop computer, a desktop computer, a communications device, a wireless telephone, a land-line telephone, a web appliance, a network router, switch or bridge, or any other machine capable of executing a set of instructions (sequential or otherwise) that specify actions to be taken by that machine. Further, while a single computer system 2500 is illustrated, the term “system” shall also be taken to include any collection of systems or sub-systems that individually or jointly execute a set, or multiple sets, of instructions to perform one or more computer functions.

The computer system 2500 may include a processor 2502 e.g., a central processing unit (CPU), a graphics processing unit (GPU), or both. The processor 2502 may be a component in a variety of systems. For example, the processor 2502 may be part of a standard personal computer or a workstation. The processor 2502 may be one or more general processors, digital signal processors, application-specific integrated circuits, field-programmable gate arrays, servers, networks, digital circuits, analog circuits, combinations thereof, or other now known or later developed devices for analysing and processing data. The processor 2502 may implement a software program, such as code generated manually (i.e., programmed).

The computer system 2500 may include a memory 2504, such as a memory 2504 that can communicate via a bus 2508. The memory 2504 may include, but is not limited to computer-readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one example, memory 2504 includes a cache or random access memory for the processor 2502. In alternative examples, the memory 2504 is separate from the processor 2502, such as a cache memory of a processor, the system memory, or other memory. The memory 2504 may be an external storage device or database for storing data. The memory 2504 is operable to store instructions executable by the processor 2502. The functions, acts or tasks illustrated in the figures or described may be performed by the programmed processor 2502 for executing the instructions stored in the memory 2504. The functions, acts or tasks are independent of the particular type of instructions set, storage media, processor or processing strategy and may be performed by software, hardware, integrated circuits, firmware, micro-code and the like, operating alone or in combination. Likewise, processing strategies may include multiprocessing, multitasking, parallel processing and the like.

As shown, the computer system 2500 may or may not further include a display unit 2510, to such as a liquid crystal display (LCD), an organic light-emitting diode (OLED), a flat panel display, a solid-state display, a cathode ray tube (CRT), a projector, a printer or other now known or later developed display device for outputting determined information. The display 2510 may act as an interface for the user to see the functioning of the processor 2502, or specifically as an interface with the software stored in the memory 2504 or the drive unit 2516.

Additionally, the computer system 2500 may include an input device 2512 configured to allow a user to interact with any of the components of system 2500. The computer system 2500 may also include a disk or optical drive unit 2516. The disk drive unit 2516 may include a computer-readable medium 2522 in which one or more sets of instructions 2524, e.g. software, can be embedded. Further, the instructions 2524 may embody one or more of the methods or logic as described. In a particular example, the instructions 2524 may reside completely, or at least partially, within the memory 2504 or within the processor 2502 during execution by the computer system 2500.

The present invention contemplates a computer-readable medium that includes instructions 2524 or receives and executes instructions 2524 responsive to a propagated signal so that a device connected to a network 2526 can communicate voice, video, audio, images, or any other data over the network 2526. Further, the instructions 2524 may be transmitted or received over the network 2526 via a communication port or interface 2520 or using a bus 2508. The communication port or interface 2520 may be a part of the processor 2502 or maybe a separate component. The communication port 2520 may be created in software or maybe a physical connection in hardware. The communication port 2520 may be configured to connect with a network 2526, external media, the display 2510, or any other components in system 2500, or combinations thereof. The connection with the network 2526 may be a physical connection, such as a wired Ethernet connection or may be established wirelessly as discussed later. Likewise, the additional connections with other components of the system 2500 may be physical or may be established wirelessly. The network 2526 may alternatively be directly connected to the bus 2508.

The network 2526 may include wired networks, wireless networks, Ethernet AVB networks, or combinations thereof. The wireless network may be a cellular telephone network, an 802.11, 802.16, 802.20, 802.1Q or WiMax network. Further, the network 826 may be a public network, such as the Internet, a private network, such as an intranet, or combinations thereof, and may utilize a variety of networking protocols now available or later developed including, but not limited to TCP/IP based networking protocols. The system is not limited to operation with any particular standards and protocols. For example, standards for Internet and other packet-switched network transmissions (e.g., TCP/IP, UDP/IP, HTML, and HTTP) may be used.

Accordingly, the present invention provides an accelerated strategy creation. the present invention provides a secure and reliable platform. The present methodology provides a taxonomy driven strategy that ensures coverage and consistency in the quality engineering thought process for your engagement. Further, the present methodology provides a customized document and appropriate recommendation based on user input. It ensures quality engineering principles. It also facilitates the implementation of quality engineering principles across all types of engagements—Development, Testing, Modernization, Migration etc.

Unless otherwise defined, all technical and scientific terms used herein have the same meaning as commonly understood by one of ordinary skilled in the art to which this invention belongs. The system, methods, and examples provided herein are illustrative only and not intended to be limiting.

Embodiments of the disclosure will be described below in detail with reference to the accompanying drawings. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

While specific language has been used to describe the present subject matter, any limitations arising on account thereto, are not intended. As would be apparent to a person in the art, various working modifications may be made to the method in order to implement the inventive concept as taught herein. The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment.

We claim:

1. A method for automatically generating a customized test strategy document and providing recommendation, the method comprising:
selecting by a user, a test type from a set of test types, wherein the test type is indicative of a required functionality for a test project;
outputting a first question associated with the selected test type along with a first set of options, based on a Quality Engineering (QE) taxonomy having a plurality of attributes defined for the selected test type;
selecting, by the user, at least one option, as a first response from the first set of options to the first question;
assigning a first score to the selected option based on the plurality of attributes in the QE taxonomy;
generating a second question associated with the selected test type based on the first response to the first question, wherein the second question is generated along with a second set of options;
selecting, by the user, at least one options, as a second response from the second set of options to the second question;
assigning a second score to the selected second option based on the plurality of attributes in the QE taxonomy;
analyzing a total response based on at least one of the first response and the second response;
generating a customized test strategy document for the selected test type based on the analysis; and
recommending at least one missing attribute from the plurality of attributes based on at least one of a total score obtained from first score and the second score and the customized test strategy document.

2. The method as claimed in the claim 1, wherein the QE taxonomy and the plurality of attributes are predefined standards for the selected test type in a test project.

3. The method as claimed in claim 1, wherein assigning of the first score and the second score, comprises:
comparing the first response and the second response with a standard response that is predefined for the selected test type in the QE taxonomy for each of the attribute in the QE taxonomy for the selected test type; and
assigning the first score and the second score based on the comparison, wherein each of the first score and the second score is indicative of deviation of response from the standard response.

4. The method as claimed in the claim 3, wherein the each of the attributes is predefined in accordance with a predefined standards for the test project.

5. The method as claimed in claim 1, further comprising:
retrieving a predefined boiler text, from a database, respective of each of the selected options; and
generating the customized test strategy document based on the retrieved predefined boiler text and the selected options.

6. The method as claimed in the claim 1, wherein the recommending at least one missing attribute from the plurality of attributes:
comparing the total response for the selected test type with a recommendation set of data defined in accordance with a predefined standards for the selected test type in the test project based on the total score; and
generating a recommendation document comprising the missing attributes for the selected test type in the test project based on the recommendation set of data.

7. The method as claimed in the claim 1, wherein the plurality of attributes is defined as QE Taxonomy elements in accordance with the standard of the QE taxonomy.

8. A system for automatically generating a customized test strategy document and providing recommendation, the system comprising:
a statutory repository 203, a QE taxonomy entity, and attribute DB 205, and QE benchmark Recommendation's repository 207 operatively coupled with each other;
one or more processors is operatively coupled with a memory and in communication with the statutory repository 203, the QE taxonomy entity, and attribute DB 205, and the QE benchmark Recommendation's repository 207 for accessing data, the one or more processors is configured to:
select by a user, a test type from a set of test types, wherein the test type is indicative of a required functionality for a test project;
output a first question associated with the selected test type along with a first set of options, based on a (Quality Engineering) QE taxonomy having a plurality of attributes defined for the selected test type
select, by the user, at least one option, as a first response from the first set of options to the first question;
assign a first score to the selected option based on the plurality of attributes in the QE taxonomy;
generate a second question associated with the selected test type based on the first response to the first question, wherein the second question is generated along with a second set of options;
select, by the user, at least one options, as a second response from the second set of options to the second question;
assign a second score to the selected second option based on the plurality of attributes in the QE taxonomy;
analyze a total response based on at least one of the first response and the second response;
generate a customized test strategy document for the selected test type based on the analysis; and
recommend at least one missing attribute from the plurality of attributes based on at least one of a total score obtained from first score and the second score and the customized test strategy document.

9. The system as claimed in the claim 8, wherein the QE taxonomy and the plurality of attributes are predefined standards for the selected test type in a test project.

10. The system as claimed in claim 8, wherein for assigning of the first score and the second score, the one or more processors is configured to:
compare the first response and the second response with a standard response that is predefined for the selected test type in the QE taxonomy for each of the attribute in the QE taxonomy for the selected test type; and
assign the first score and the second score based on the comparison, wherein each of the first score and the second score is indicative of deviation of response from the standard response.

11. The system as claimed in the claim 10, wherein the each of the attributes is predefined in accordance with a predefined standards for the test project.

12. The system as claimed in claim 8, wherein the one or more processors is configured to:
retrieve a predefined boiler text, from a database, respective of each of the selected options; and
generate the customized test strategy document based on the retrieved predefined boiler text and the selected options.

13. The system as claimed in the claim 8, wherein for the recommending at least one missing attribute from the plurality of attributes, the one or more processors is configured to:
compare the total response for the selected test type with a recommendation set of data defined in accordance with a predefined standards for the selected test type in the test project based on the total score; and
generate a recommendation document comprising the missing attributes for the selected test type in the test project based on the recommendation set of data.

14. The system as claimed in the claim 8, wherein the plurality of attributes is defined as QE Taxonomy elements in accordance with the standard of the QE taxonomy that is stored on in the QE taxonomy entity and attribute DB 205.
